(19) United States
(12) Patent Application Publication
(10) Pub. No.: US 2026/0346660 A1
(43) Pub. Date: Nov. 5, 2026

(54) CONNECTION APPARATUS AND TRANSPORT BODY

(71) Applicant: SIMOTEC CO., LTD., Osaka (JP)

(72) Inventor: Yasuhiro SUZUKI, Osaka (JP)

(21) Appl. No.: 19/660,845

(22) Filed: Apr. 28, 2026

(30) Foreign Application Priority Data
May 2, 2025 (JP) 2025-076912

(51) Int. Cl. B60D 1/04; B60D 1/00; B60D 1/24

(52) U.S. Cl. CPC B60D 1/04; B60D 1/246; B60D 2001/005

(57) ABSTRACT

A connection apparatus includes a body portion, rotatable swinging members, a slider, an attraction portion, and a magnet portion. The slider is offset to the right from a connection portion and a rotation shaft. The slider moves in a front-rear direction in conjunction with the swinging members. The attraction portion moves with the slider facing the magnet portion. Rotation of the swinging member switches between a connection state where a connected portion engages the connection portion and an open state. When the attraction portion is attracted to the magnet portion, movement of the slider is restricted to maintain the connection state.

### CROSS REFERENCE TO RELATED APPLICATIONS

The present invention claims priority under 35 U.S.C. § 119 to Japanese Application No. 2025-076912 filed on May 2, 2025, the entire contents of which being incorporated herein by reference.

### TECHNICAL FIELD

The present invention relates to a connection apparatus and a transport body.

### BACKGROUND ART

Various connection apparatuses are used to connect a transport vehicle and a carriage towed by the transport vehicle. For example, Patent Literature 1 discloses a connection apparatus that connects an object to be connected using magnetic force.

The connection apparatus disclosed in Patent Literature 1 includes a magnet portion, a hook that rotates around a shaft as a fulcrum, a body portion having a connection space that is partially open in a plan view, a slider movable in a pushing direction in which the slider is pushed into the body portion and a pulling-out direction in which the slider is pulled out from the body portion, and an attraction portion made of a magnetic material movable in the pushing direction and the pulling-out direction in accordance with movement of the slider. The hook is provided so as to rotate in accordance with the movement of the slider, brings the connection space into a closed state in accordance with the movement of the slider in the pushing direction, and brings a part of the connection space into an open state in accordance with the movement of the slider in the pulling-out direction. In a state where the slider has moved in the pushing direction until the connection space is in the closed state, the magnet portion and the attraction portion are attracted to each other by magnetic force of the magnet portion, whereby the state in which the connection space is closed is maintained.

In the connection apparatus disclosed in Patent Literature 1, the slider is pushed by the object to be connected until the connection space is in the closed state, whereby the object to be connected is connected, and the state in which the object to be connected is connected can be maintained by the magnet portion and the attraction portion being attracted to each other. Thus, in the connection apparatus disclosed in Patent Literature 1, the object to be connected can be easily connected by pushing the slider with the object to be connected.

### LIST OF PRIOR ART DOCUMENTS

### Patent Document

Patent Document 1: Japanese Unexamined Patent Application Publication No. 2023-131135

### SUMMARY OF INVENTION

### Technical Problem

In the connection apparatus disclosed in Patent Literature 1, the connection space, the slider, the attraction portion, and the magnet portion are arranged so as to be aligned in a straight line along the pushing direction. For this reason, it is difficult to reduce the dimension of the connection apparatus in the pushing direction.

Therefore, an object of the present invention is to provide a connection apparatus capable of reducing a dimension in a movement direction of a slider, and a transport body including the connection apparatus.

### Solution to Problem

A connection apparatus comprising:
a body portion having a concave portion opening toward one side in a first direction;
a first swinging member supported by the body portion so as to be rotatable around a first rotation shaft extending in a second direction orthogonal to the first direction;
a second swinging member having a hook portion and supported by the body portion so as to be rotatable around a second rotation shaft extending in the second direction;
a slider provided on the one side relative to a center portion of the concave portion and the second rotation shaft in a third direction orthogonal to the first direction and the second direction, the slider being coupled to the first swinging member and the second swinging member so as to move in the first direction in conjunction with rotation operations of the first swinging member and the second swinging member;
an attraction portion attached to the slider so as to move in the first direction in conjunction with movement of the slider in the first direction, at least a part of the attraction portion being made of a magnetic material; and
a magnet portion supported by the body portion so as to face the attraction portion in the first direction,
wherein the second swinging member is rotated around the second rotation shaft to be switched between a connection state in which the hook portion covers the center portion of the concave portion from the one side in the first direction when viewed from the second direction, and an open state in which the hook portion is retracted to an outside in the third direction from the center portion of the concave portion relative to a position in the connection state when viewed from the second direction,
wherein, when the connection state is established, the attraction portion is attracted to the magnet portion, whereby the movement of the slider and the rotation of the first swinging member and the second swinging member are restricted, and the connection state is maintained, and
wherein, in the open state, a part of the first swinging member is positioned inside the concave portion when viewed from the second direction.

### ADVANTAGEOUS EFFECTS OF INVENTION

According to the present invention, the dimension of the connection apparatus in the movement direction of the slider can be reduced.

### BRIEF DESCRIPTION OF DRAWINGS

FIG. 1A and FIG. 2B are schematic views showing a transport body including a connection apparatus according to an embodiment of the present invention, and an object to be connected to the transport body.

FIG. 2 is a plan view showing the connection apparatus.

FIG. 3 is a plan view showing an inside of the connection apparatus in an open state.

FIG. 4 is a plan view showing the inside of the connection apparatus in a connection state.

FIG. 5 is a schematic cross-sectional view showing a portion A-A in FIG. 3.

FIG. 6 is a diagram for explaining an effect of an elastic member provided between a slider and an attraction portion.

FIG. 7 is a diagram for explaining another effect of the elastic member provided between the slider and the attraction portion.

FIG. 8 is a plan view showing a connection apparatus according to a modification.

### DESCRIPTION OF EMBODIMENTS

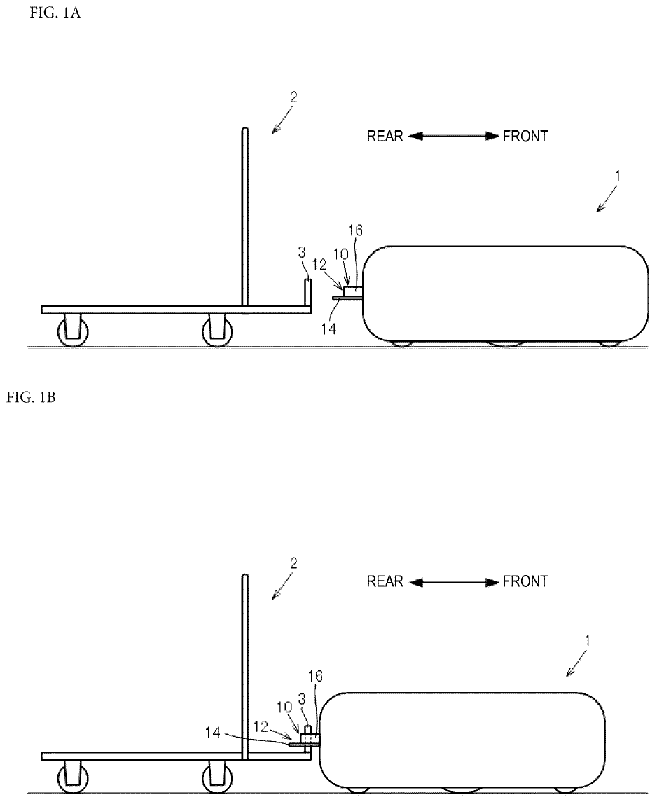

Hereinafter, a connection apparatus and a transport body according to embodiments of the present invention will be described with reference to the drawings. FIG. 1A and FIG. 1B are a schematic views showing a transport body including a connection apparatus according to an embodiment of the present invention, and an object to be connected to the transport body. FIG. 1A shows a state before an object to be connected 2 is connected to a transport body 1, and FIG. 1B shows a state in which the object to be connected 2 is connected to the transport body 1.

As shown in FIG. 1A and FIG. 1B, a connection apparatus 10 according to an embodiment of the present invention is provided on the transport body 1. In the present embodiment, the transport body 1 is, for example, an unmanned transport vehicle (AGV (Automated Guided Vehicle)). Note that the transport body on which the connection apparatus according to the embodiment of the present invention is provided is not limited to the unmanned transport vehicle, and the connection apparatus can be provided on various apparatuses capable of connecting and transporting an object, such as an industrial robot, a crane apparatus, a helicopter, and a drone.

In the present embodiment, the object to be connected 2 is a carriage including a rod-shaped connected portion 3. As shown in FIG. 1B, in the present embodiment, the connected portion 3 and the connection apparatus 10 are connected, whereby the object to be connected 2 is connected to the transport body 1. Thereby, the object to be connected 2 can be towed by the transport body 1. Note that the shape of the connected portion 3 is not limited to the rod shape and may be another shape such as a ring shape as long as the shape can be connected to the connection apparatus 10.

### Configuration of Connection Apparatus

Hereinafter, the connection apparatus 10 will be described in detail. In the following description, a towing direction of the object to be connected 2 by the transport body 1 is defined as “front”, and a positional relationship of each portion of the connection apparatus 10 will be described.

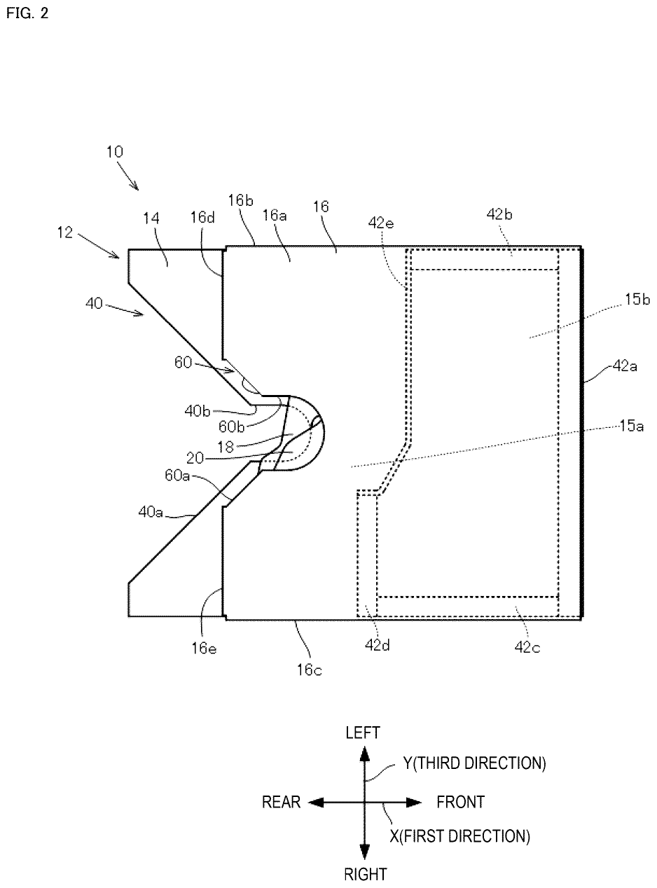

FIG. 2 is a plan view showing the connection apparatus 10. FIG. 2 shows an arrow X indicating a front-rear direction and an arrow Y indicating a left-right direction. Hereinafter, the front-rear direction is referred to as a “front-rear direction X”, and the left-right direction is referred to as a “left-right direction Y”. Also, in each drawing described later, the arrows indicating the front-rear direction X and the left-right direction are shown as appropriate, and further, an arrow Z indicating an up-down direction is shown as appropriate. Hereinafter, the up-down direction is referred to as an “up-down direction Z”. The front-rear direction X, the left-right direction Y, and the up-down direction Z are directions orthogonal to each other. Note that the positional relationship of each portion when the connection apparatus is attached to the transport body is not limited to the front-rear, left-right, and up-down positional relationships shown in each drawing. In the present embodiment, the front-rear direction X corresponds to a first direction, the up-down direction Z corresponds to a second direction, and the left-right direction corresponds to a third direction.

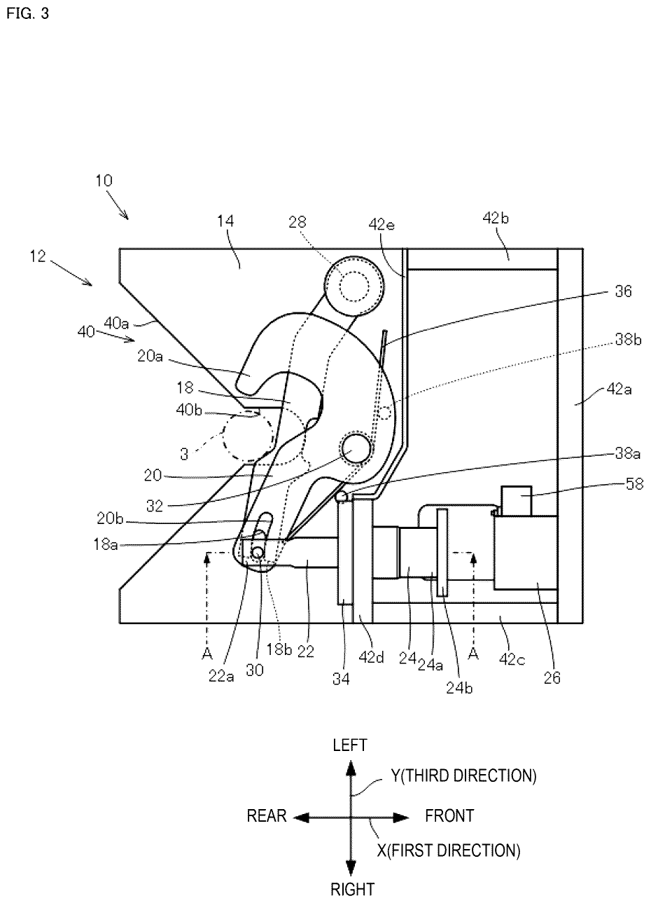

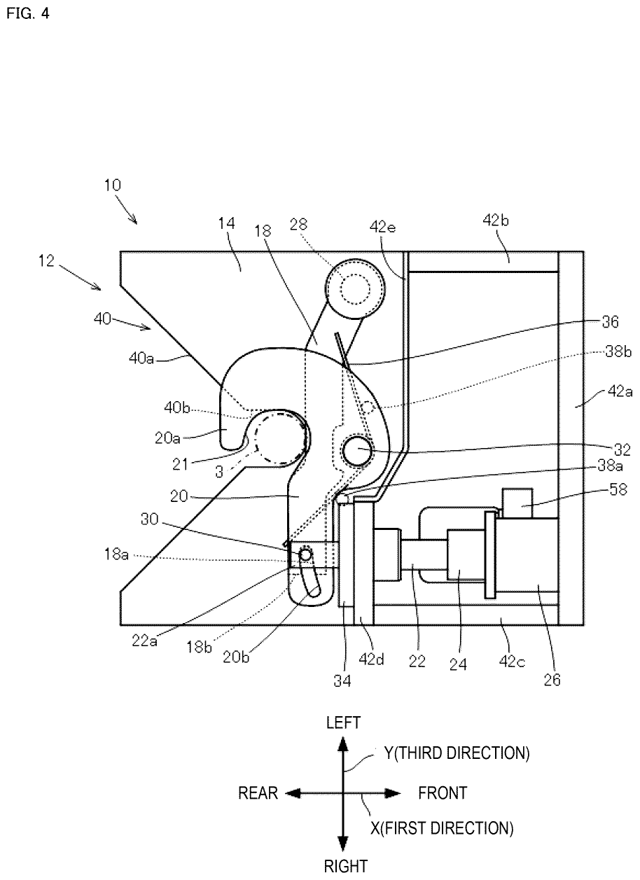

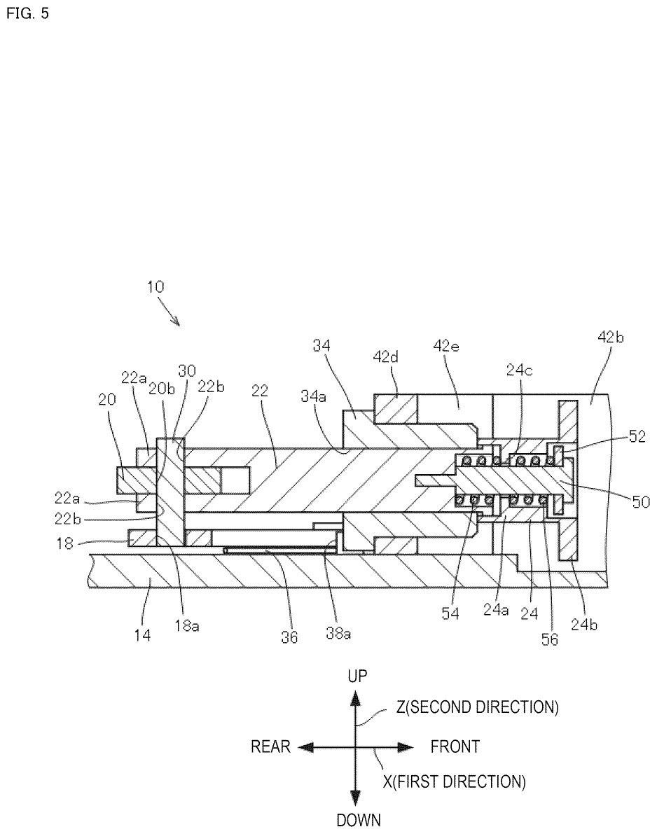

As shown in FIGS, 1A, FIG. 1B and FIG. 2, the connection apparatus 10 has a box-shaped body portion 12. The body portion 12 includes a support portion 14, a lid portion 16, and vertical wall portions 42a to 42e. In the present embodiment, the lid portion 16 is provided so as to cover the support portion 14 and the vertical wall portions 42a to 42e from above. FIG. 3 and FIG. 4 are plan views showing the connection apparatus 10 in a state where the lid portion 16 is removed. Also, FIG. 5 is a schematic cross-sectional view showing a portion A-A in FIG. 3.

The support portion 14 is formed in a plate shape. As shown in FIG. 2 and FIG. 3, a concave portion 40 is formed in a rear portion of the support portion 14 so as to open toward the rear. In the present embodiment, the concave portion 40 includes a tapered portion 40a and a connection portion 40b.

The tapered portion 40a is formed such that the width thereof gradually decreases from a rear edge of the support portion 14 toward the front. Note that in this specification, the “width” means a length in the left-right direction Y. The connection portion 40b is formed so as to be recessed further forward from a front end of the tapered portion 40a. In a plan view, the connection portion 40b has a U-shape so as to open toward the rear. The connection portion 40b is a portion into which the connected portion 3 is fitted when connecting the object to be connected 2 to the connection apparatus 10.

As shown in FIG. 3, the vertical wall portion 42a is provided so as to extend in the left-right direction along a front edge of the support portion 14, the vertical wall portion 42b is provided so as to extend in the front-rear direction along a left edge of the support portion 14, and the vertical wall portion 42c is provided so as to extend in the front-rear direction along a right edge of the support portion 14. The vertical wall portion 42d is provided so as to extend to the left from a rear end portion of the vertical wall portion 42c. The vertical wall portion 42e is provided so as to connect a rear end portion of the vertical wall portion 42b and a left end portion of the vertical wall portion 42d. The vertical wall portions 42a, 42b, 42c, 42d, and 42e are supported by the support portion 14 so as to rise upward from the support portion 14.

As shown in FIG. 2, the lid portion 16 has a plate-shaped top plate portion 16 a. A concave portion 60 is formed in a rear portion of the top plate portion 16a so as to open toward the rear. In the present embodiment, similarly to the concave portion 40, the concave portion 60 has a tapered portion 60a and a connection portion 60b. The tapered portion 60a is formed such that a width thereof gradually decreases from a rear edge of the top plate portion 16a toward the front. The connection portion 60b is formed so as to be recessed further forward from a front end of the tapered portion 60a. In a plan view, the connection portion 60b has a U-shape so as to open toward the rear. The connection portion 60b is a portion into which the connected portion 3 is fitted when connecting the object to be connected 2 to the connection apparatus 10. In the present embodiment, a rear edge portion of the lid portion 16 is located forward of the rear edge portion of the support portion 14 such that a part of the lid portion 16 is not located inside the concave portion 40 in a plan view.

The lid portion 16 further includes vertical wall portions 16b, 16c, 16d, and 16e. The vertical wall portion 16b is formed so as to extend downward from the left edge of the top plate portion 16a. The vertical wall portion 16b is formed so as to cover the vertical wall portions 42b and 42e from the left side and extend further rearward than the vertical wall portions 42b and 42e. The vertical wall portion 16c is formed so as to extend downward from the right edge of the top plate portion 16a. The vertical wall portion 16c is formed so as to cover the vertical wall portions 42c and 42d from the right side and extend further rearward than the vertical wall portions 42c and 42d.

The vertical wall portion 16d is formed so as to extend downward from the rear edge of the top plate portion 16a on the left side of the concave portion 60. The vertical wall portion 16e is formed so as to extend downward from the rear edge of the top plate portion 16a on the right side of the concave portion 60. In the present embodiment, a space between the support portion 14 and the lid portion 16 (an internal space of the body portion 12) is partitioned into a first region 15a rearward of the vertical wall portions 42d and 42e, and a second region 15b forward of the vertical wall portions 42d and 42e. In the present embodiment, the vertical wall portions 42d and 42e correspond to partition wall portions.

In the present embodiment, the first region 15a is a region surrounded by the vertical wall portions 42d and 42e, the top plate portion 16a, and the vertical wall portions 16b, 16c, 16d, and 16e. The first region 15a is connected to a space rearward of the lid portion 16 below the concave portion 60. In other words, the lid portion 16 opens toward the rear below the concave portion 60. The second region 15b is a region surrounded by the vertical wall portions 42a, 42b, 42c, 42d, and 42e and the top plate portion 16a.

As shown in FIG. 3 and FIG. 4, the first swinging member 18, the second swinging member 20, the slider 22, the attraction portion 24, and the magnet portion 26 are supported by the body portion 12. The first swinging member 18 is supported by the support portion 14 so as to be rotatable around a first rotation shaft 28 extending in the up-down direction. In the present embodiment, the first swinging member 18 is an arm-shaped member provided so as to extend in the left-right direction. In the present embodiment, a left end portion of the first swinging member 18 is rotatably supported by the first rotation shaft 28. In the present embodiment, the first rotation shaft 28 is provided on the left side of a center portion of the concave portion 40. Note that in this specification, the center portion of the concave portion means a portion into which the connected portion is fitted when connecting the object to be connected to the connection apparatus. Therefore, in the present embodiment, the center portion of the concave portion 40 means the connection portion 40b into which the connected portion 3 is fitted. In the present embodiment, the first rotation shaft 28 is provided on the left side of the connection portion 40b.

As shown in FIGS. 3 to 5, a guide portion 18a into which a connection member 30 described later is fitted is formed in a right end portion of the first swinging member 18. As shown in FIG. s 3 and 4, in the present embodiment, the guide portion 18a is formed so as to be recessed from a right edge portion 18b of the first swinging member 18 toward the left side. In the present embodiment, the guide portion 18a is curved in an arc shape so as to be convex toward the rear side in a plan view. Further, as shown in FIG. 5, in the present embodiment, the guide portion 18a is formed so as to penetrate the first swinging member 18 in the up-down direction.

As shown in FIG. 3 and FIG. 4, the second swinging member 20 is supported by the support portion 14 so as to be rotatable around a second rotation shaft 32 extending in the up-down direction. In the present embodiment, the second rotation shaft 32 is provided on the right side of the first rotation shaft 28. Further, in the present embodiment, a center of the second rotation shaft 32 is located on the left side of a right edge of the connection portion 40b in the left-right direction Y. More specifically, in the present embodiment, the second rotation shaft 32 is provided forward of the connection portion 40b.

A key-shaped hook portion 20a is provided on a left end portion of the second swinging member 20. The connection apparatus 10 is switched, by rotation of the second swinging member 20 around the second rotation shaft 32, between a connection state (a state shown in FIG. 4) in which the hook portion 20a covers the center portion of the concave portion 40 (the connection portion 40b) from the rear in a plan view, and an open state (a state shown in FIG. 3) in which the hook portion 20a is retracted to the outside in the left-right direction from the center portion of the concave portion 40 relative to a position in the connection state in a plan view.

As shown in FIG. 4, an inclined edge portion 21 is provided at a tip portion of the hook portion 20a. The inclined edge portion 21 is inclined relative to the left-right direction Y such that, when the connection apparatus 10 is in the connection state, the inclined edge portion 21 faces the front side in a plan view, and is located further toward the front side as the inclined edge portion 21 separates from a tip of the hook portion 20a in the left-right direction Y.

As shown in FIG. s 3 to 5, a guide portion 20b into which the connection member 30 is fitted is formed in a right end portion of the second swinging member 20. In the present embodiment, the guide portion 20b is a through hole formed in the right end portion of the second swinging member 20. The guide portion 20b is curved in an arc shape so as to be convex toward the rear side in a plan view.

As shown in FIG. 3 and FIG. 4, the slider 22 is provided on the right side of the center portion of the concave portion 40, the first rotation shaft 28, and the second rotation shaft 32. In the present embodiment, the slider 22 has a substantially columnar shape. As shown in FIG. 5, in the present embodiment, the slider 22 is supported by the vertical wall portion 42d via a cylindrical guide member 34. The guide member 34 is provided so as to penetrate the vertical wall portion 42d in the front-rear direction X. In the present embodiment, a through hole 34a is formed in the guide member 34 so as to penetrate in the front-rear direction X. The slider 22 is slidably inserted into the through hole 34a. Thereby, a movement direction of the slider 22 is restricted to the front-rear direction X.

As shown in FIG. 3 and FIG. 4, the slider 22 is connected to the first swinging member 18 and the second swinging member 20 so as to move in the front-rear direction in conjunction with the rotation operations of the first swinging member 18 and the second swinging member 20. As shown in FIG. 5, in the present embodiment, a pair of plate-shaped support portions 22a are provided at a rear end portion of the slider 22 so as to be separated from each other in the up-down direction Z. A through hole 22b penetrating in the up-down direction is formed in each support portion 22a. In the present embodiment, in a state where the right end portion of the second swinging member 20 is fitted between the pair of support portions 22a, the connection member 30 is passed through the guide portion 18a of the first swinging member 18, the through holes 22b of the pair of support portions 22a, and the guide portion 20b of the second swinging member 20, whereby the first swinging member 18, the second swinging member 20, and the slider 22 are connected. In the present embodiment, the connection member 30 has a columnar shape, and is inserted into the guide portion 18a and the guide portion 20b so as to be slidable in the guide portion 18a and the guide portion 20b.

As shown in FIG. 3, when the connection apparatus 10 is in the open state, a part of the first swinging member 18 is positioned inside the concave portion 40 in a plan view. More specifically, a part of the first swinging member 18 is positioned inside the connection portion 40b in a plan view.

As shown in FIG. 3 and FIG. 4, a rotation force applying member 36 is attached to the second rotation shaft 32. The rotation force applying member 36 applies a force to the second swinging member 20 to rotate the second swinging member 20 around the second rotation shaft 32 so that the connection apparatus 10 is in the open state. In the present embodiment, a torsion spring is used as the rotation force applying member 36. Although detailed description is omitted, in the present embodiment, the second rotation shaft 32 is fitted into a coil portion of the torsion spring, one arm portion of the torsion spring is hooked on a projection 38a provided on the support portion 14, and the other arm portion is hooked on a projection 38b provided on the second swinging member 20, whereby the rotation force is applied to the second swinging member 20. Note that the rotation force applying member only needs to be configured to apply the rotation force to the second swinging member 20, and an elastic member other than the torsion spring may be used as the rotation force applying member.

An attraction portion 24 is attached to a front end portion of the slider 22. At least a part of the attraction portion 24 is made of a magnetic material so as to be attracted to the magnet portion 26. For example, a portion of the attraction portion 24 that comes into contact with the magnet portion 26 is made of a magnetic material. In the present embodiment, the attraction portion 24 includes a cylindrical portion 24a and a flange portion 24b. The flange portion 24b is formed in an annular shape so as to project toward the outside of the cylindrical portion 24a from a front end portion of the cylindrical portion 24a. In the present embodiment, for example, at least the flange portion 24b is made of a magnetic material.

As shown in FIG. 3 to FIG. 5, in the present embodiment, the attraction portion 24 is attached to the slider 22 so as to be movable in the front-rear direction X relative to the slider 22. In the present embodiment, the front end portion of the slider 22 is slidably fitted into a rear end portion of the cylindrical portion 24a.

As shown in FIG. 5, in the present embodiment, an annular flange portion 24c projecting inward is provided on an inner peripheral surface side of the cylindrical portion 24a. A columnar guide member 50 is provided inside the attraction portion 24. A rear end portion of the guide member 50 is fixed to the front end portion of the slider 22. An annular flange portion 52 is provided at a front end portion of the guide member 50. An elastic member 54 is provided so as to be sandwiched between the flange portion 24c and the front end portion of the slider 22 in the front-rear direction X. Further, an elastic member 56 is provided so as to be sandwiched between the flange portion 24c and the flange portion 52 in the front-rear direction X. In the present embodiment, for example, compression coil springs as the elastic members 54 and 56 are fitted onto the guide member 50. The elastic members 54 and 56 are provided to buffer a force in the front-rear direction X generated between the attraction portion 24 and the slider 22.

As shown in FIG. 3 and FIG. 4, the magnet portion 26 is provided so as to face the attraction portion 24 in the front-rear direction X. In the present embodiment, the magnet portion 26 is supported by the vertical wall portion 42a. In the present embodiment, the magnet portion 26 is provided forward of the attraction portion 24. The magnet portion 26 is configured to be able to attract the attraction portion 24 using magnetic force. Although detailed description is omitted, in the present embodiment, the magnet portion 26 is an electro-permanent magnet (EPM) apparatus having a magnetic force generation portion including a coil, a first magnet capable of switching a magnetization direction depending on a direction of current to the coil, and a second magnet having a fixed magnetization direction. In the present embodiment, for example, a state of the magnet portion 26 is switched between a state of attracting the attraction portion 24 and a state of not attracting the attraction portion 24 by a current supplied from a control device via wiring (not shown). Note that the control device may be an external device of the connection apparatus 10 (for example, a control device provided on the transport body 1) or may be provided in the connection apparatus 10.

In the present embodiment, a contact detection unit 58 configured to detect contact between the attraction portion 24 and the magnet portion 26 is provided on the magnet portion 26 or in the vicinity of the magnet portion 26. When detecting the contact between the attraction portion 24 and the magnet portion 26, the contact detection unit 58 transmits a detection signal to the control device via wiring (not shown). Upon receiving the detection signal from the contact detection unit 58, the control device supplies a current to the magnet portion 26, for example, to switch the state of the magnet portion 26 to the state of attracting the attraction portion 24. Thereby, a state in which the attraction portion 24 and the magnet portion 26 are attracted to each other is maintained.

### Connection Method

Next, a method for connecting the object to be connected 2 and the connection apparatus 10 will be described. As a premise, when connecting the object to be connected 2 and the connection apparatus 10, the state of the connection apparatus 10 is set to the open state shown in FIG. 3. In this state, as shown in FIG. 1A and FIG. 1B, when connecting the object to be connected 2 and the connection apparatus 10, the transport body 1 and the object to be connected 2 are brought close to each other. Specifically, as shown in FIG. 3, the transport body 1 and the object to be connected 2 are brought close to each other such that the connected portion 3 fits into the connection portion 40b of the concave portion 40 and the connection portion 60b (see FIG. 2) of the concave portion 60 (see FIG. 2).

The transport body 1 and the object to be connected 2 are brought further close to each other, and the first swinging member 18 is pushed forward by the connected portion 3 to rotate the first swinging member 18 around the first rotation shaft 28. Thereby, the second swinging member 20 rotates around the second rotation shaft 32, and the connection apparatus 10 enters the connection state shown in FIG. 4. As a result, the hook portion 20a is positioned on the rear side of the connected portion 3. Further, the slider 22 moves forward in conjunction with the rotation operation of the first swinging member 18, and the attraction portion 24 comes into contact with the magnet portion 26. At this time, the attraction portion 24 is attracted to the magnet portion 26, whereby the movement of the slider 22 to the rear and the rotation of the first swinging member 18 and the second swinging member 20 are restricted. As a result, the connection state is maintained, and it is possible to prevent the connected portion 3 from slipping out backward from the connection portion 40b. That is, the state in which the connection apparatus 10 and the object to be connected 2 are connected can be maintained.

When separating the connection apparatus 10 and the object to be connected 2, the state of the magnet portion 26 is switched to the state of not attracting the attraction portion 24. Thereby, the attraction portion 24 separates from the magnet portion 26, and a state is established in which the movement of the slider 22 to the rear and the rotation of the first swinging member 18 and the second swinging member 20 are possible. In this case, the connection apparatus 10 enters the open state by the rotation force applied from the rotation force applying member 36 to the second swinging member 20. As a result, the connected portion 3 can be removed backward from the connection portion 40b, and the connection apparatus 10 and the object to be connected 2 can be separated.

### Functions and Effects

In the connection apparatus 10 according to the present embodiment, the slider 22 for moving the attraction portion 24 in the front-rear direction is provided on the right side of the connection portion 40b of the concave portion 40. In this case, a position where the connected portion 3 pushes the first swinging member 18 and a position of the slider 22 can be shifted in the left-right direction. Thereby, a length of the connection apparatus 10 in the front-rear direction X can be shortened. That is, the dimension of the connection apparatus 10 in the movement direction of the slider 22 can be reduced.

Further, in the present embodiment, the first swinging member 18 is provided so as to be rotatable around the first rotation shaft 28. Therefore, even when a pushing direction of the first swinging member 18 by the connected portion 3 is inclined relative to the front-rear direction X or parallel to the front-rear direction X in a plan view, there is little difference in the rotation operation of the first swinging member 18. Thereby, even when the pushing direction of the first swinging member 18 is inclined relative to the front-rear direction X, the slider 22 can be appropriately moved in the front-rear direction X, and the connection apparatus 10 and the object to be connected 2 can be smoothly connected.

Further, in the present embodiment, the slider 22 is provided on the right side of the second rotation shaft 32 of the second swinging member 20. Thus, by shifting the position of the slider 22 and the position of the second rotation shaft 32 in the left-right direction Y, it is possible to weaken a force with which the second swinging member 20 pushes the slider 22 backward when the hook portion 20a is pushed backward by the connected portion 3 in the connection apparatus 10 in the connection state. Thereby, the state in which the attraction portion 24 and the magnet portion 26 are attracted to each other can be sufficiently maintained, so that a towing force of the transport body 1 can be increased. Particularly, in the connection apparatus 10 according to the present embodiment, the second rotation shaft 32 is provided forward of the connection portion 40b. Thereby, a distance between the connection member 30 and the second rotation shaft 32 can be made sufficiently large, so that a sufficiently large moment can be applied to the second swinging member 20 even if an attraction force generated between the magnet portion 26 and the attraction portion 24 is small. That is, the towing force can be sufficiently increased.

Further, in the present embodiment, the first swinging member 18 and the slider 22 are connected on the right side of the connection portion 40b, and the first rotation shaft 28 of the first swinging member 18 is provided on the left side of the connection portion 40b. In this case, when the first swinging member 18 is pushed by the connected portion 3, a forward movement amount of a connection portion between the first swinging member 18 and the slider 22 becomes larger than a forward movement amount of a portion of the first swinging member 18 pushed by the connected portion 3. Thereby, even when a pushing amount of the connected portion 3 is small, a sufficient movement amount of the slider 22 can be secured.

Also, in the present embodiment, when the first swinging member 18 is pushed by the connected portion 3, a distance from a connection portion between the first swinging member 18 and the slider 22 to the first rotation shaft 28 can be made larger than a distance from the connected portion 3 to the first rotation shaft 28. Thereby, a force applied from the slider 22 (the attraction portion 24) to the magnet portion 26 can be reduced.

Further, in the present embodiment, the first region 15a accommodating the first swinging member 18 and the second swinging member 20 and the second region 15b accommodating the attraction portion 24 and the magnet portion 26 are partitioned by the partition wall portions (the vertical wall portions 42d and 42e). In this case, even if foreign matters such as dust are generated inside the body portion 12 due to the rotation operations of the first swinging member 18 and the second swinging member 20, it is possible to suppress the foreign matters from adhering to the attraction portion 24 and the magnet portion 26. Thereby, deterioration of functions of the connection apparatus 10 can be suppressed.

In the present embodiment, the elastic members 54 and 56 buffering the force in the front-rear direction X are provided between the attraction portion 24 and the slider 22. Thereby, even when parallelism of contact surfaces between the attraction portion 24 and the magnet portion 26 is not sufficient, the attraction portion 24 can follow the magnet portion 26 to be smoothly attracted.

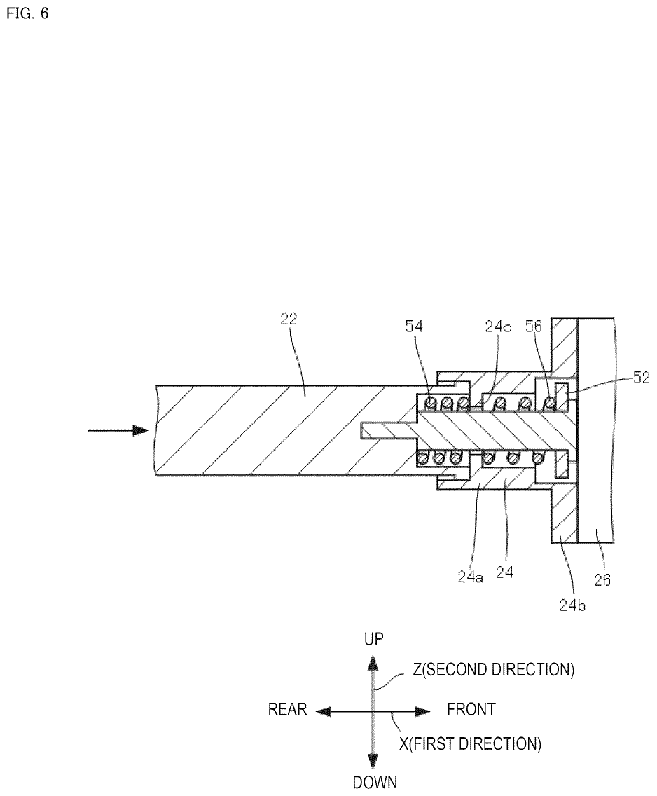

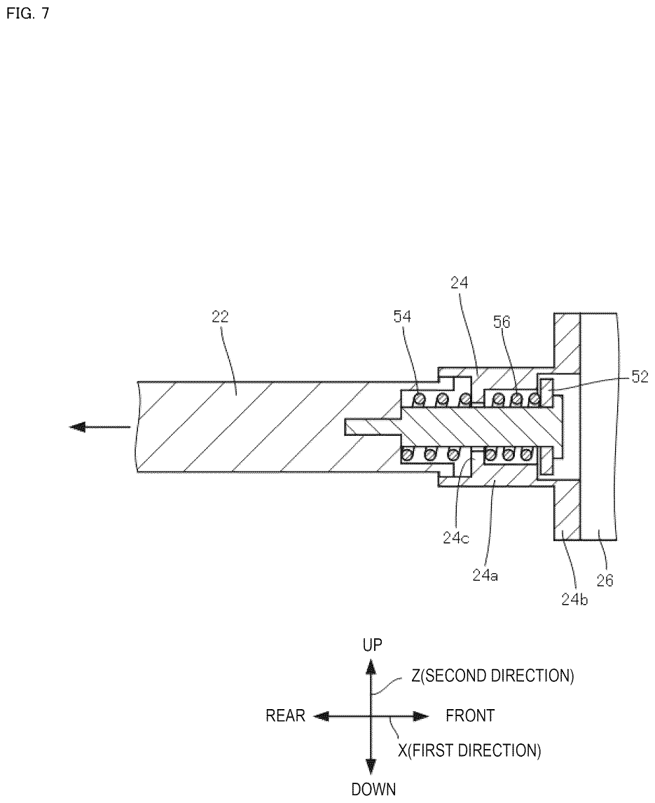

Further, the elastic members 54 and 56 also provide effects described below. FIG. 6 is a diagram for explaining an effect of the elastic member 54 provided between the slider 22 and the attraction portion 24, and FIG. 7 is a diagram for explaining an effect of the elastic member 56 provided between the slider 22 and the attraction portion 24. For example, as shown in FIG. 6, when the slider 22 moves forward and the attraction portion 24 is attracted to the magnet portion 26, the elastic member 54 is compressed, whereby an impact force applied from the slider 22 to the magnet portion 26 via the attraction portion 24 can be reduced.

Also, for example, as shown in FIG. 7, when a large force trying to move the slider 22 backward is instantaneously generated, the elastic member 56 is compressed, whereby an impact force applied from the slider 22 to the attraction portion 24 can be reduced. Thereby, even when a large force is instantaneously applied from the connected portion 3 to the second swinging member 20 during towing of the object to be connected 2, it is possible to suppress the attraction portion 24 from separating from the magnet portion 26.

In the present embodiment, the inclined edge portion 21 inclined relative to the left-right direction Y is provided on the hook portion 20a of the second swinging member 20 in the connection state. For example, when switching the connection apparatus 10 to the open state by setting the state of the magnet portion 26 to the state of not attracting the attraction portion 24, if the connection apparatus 10 does not enter the open state for some reason, it is necessary to move the connected portion 3 (the object to be connected 2) backward relative to the connection apparatus 10 to pull the connected portion 3 out from the connection portion 40b. In such a case, since the inclined edge portion 21 is provided, the connected portion 3 is not caught by the hook portion 20a, and the connected portion 3 can be smoothly pulled out from the connection portion 40b.

In the present embodiment, each of the guide portion 18a of the first swinging member 18 and the guide portion 20b of the second swinging member 20 is curved in an arc shape so as to be convex toward the side opposite to the attraction portion 24 (rearward in the present embodiment) in the front-rear direction X. By forming the guide portions 18a and 20b in such a shape, the connection member 30 can smoothly move in the guide portions 18a and 20b when the first swinging member 18 and the second swinging member 20 rotate. Thereby, the first swinging member 18 and the second swinging member 20 can be smoothly rotated.

### Modification

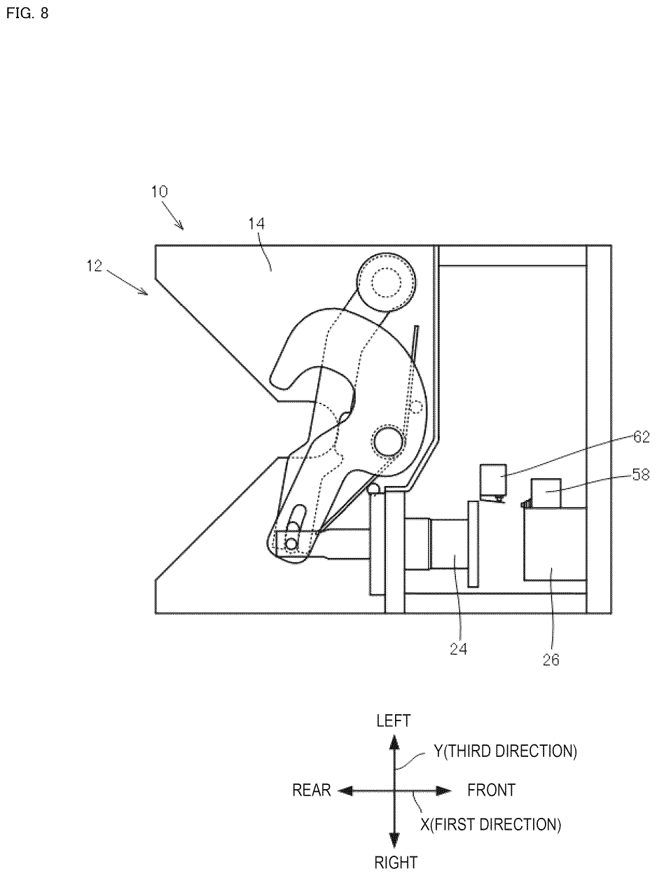

FIG. 8 is a plan view showing a connection apparatus 10 according to a modification. Although detailed description is omitted, as shown in FIG. 8, the connection apparatus 10 may further include a movement detection unit 62 configured to detect movement of the attraction portion 24 toward the magnet portion 26 side. In this case, for example, when detecting the movement of the attraction portion 24, the movement detection unit 62 transmits a detection signal to an external control device via wiring (not shown). The control device controls the transport body 1 or the object to be connected 2 to reduce an approaching speed between the transport body 1 and the object to be connected 2.

In the above-described embodiment, the case where the electro-permanent magnet apparatus is used as the magnet portion 26 has been described. However, the magnet portion 26 only needs to be “configured to be able to attract an attraction target (the attraction portion 24) using magnetic force”, and may be configured by a permanent magnet or an electromagnet. In this case, for example, in the open state, the attraction portion 24 may be separated to a position where the magnetic force of the magnet portion 26 does not reach (a case where the attraction portion 24 is not attracted by the magnet portion 26). When removing the attraction portion 24 from the magnet portion 26, the attraction portion 24 may be peeled off from the magnet portion 26 by pulling the attraction portion 24 manually using a lever or the like.

In the above-described embodiment, the case where the first rotation shaft 28 is provided on the left side of the connection portion 40b has been described. However, the first rotation shaft 28 may be provided on the right side of the connection portion 40b. In this case, the attraction portion 24 and the magnet portion 26 may be provided rearward of the slider 22, and the connection apparatus may be configured such that the slider 22 moves backward when the first swinging member 18 is pushed by the connected portion 3.

Although detailed description is omitted, the configuration of the connection apparatus 10 described above may be laterally reversed.

### INDUSTRIAL APPLICABILITY

The dimension of the connection apparatus in the movement direction of the slider can be reduced.

### REFERENCE SIGNS LIST

1 Transport body
2 Object to be connected
3 Connected portion
10 Connection apparatus
12 Body portion
14 Support portion
15a First region
15b Second region
16 Lid portion
18 First swinging member
18a Guide portion
20 Second swinging member
20a Hook portion
20b Guide portion
21 Inclined edge portion
22 Slider
24 Attraction portion
26 Magnet portion
28 First rotation shaft
30 Connection member
32 Second rotation shaft
36 Rotation force applying member
40 Concave portion
40b Connection portion
42d, 42 eVertical wall portion (Partition wall portion)
54, 56 Elastic member
58 Contact detection unit
62 Movement detection unit

1. A connection apparatus comprising:
a body portion having a concave portion opening toward one side in a first direction;
a first swinging member supported by the body portion so as to be rotatable around a first rotation shaft extending in a second direction orthogonal to the first direction;
a second swinging member having a hook portion and supported by the body portion so as to be rotatable around a second rotation shaft extending in the second direction;
a slider provided on the one side relative to a center portion of the concave portion and the second rotation shaft in a third direction orthogonal to the first direction and the second direction, the slider being coupled to the first swinging member and the second swinging member so as to move in the first direction in conjunction with rotation operations of the first swinging member and the second swinging member;
an attraction portion attached to the slider so as to move in the first direction in conjunction with movement of the slider in the first direction, at least a part of the attraction portion being made of a magnetic material; and
a magnet portion supported by the body portion so as to face the attraction portion in the first direction,
wherein the second swinging member is rotated around the second rotation shaft to be switched between a connection state in which the hook portion covers the center portion of the concave portion from the one side in the first direction when viewed from the second direction, and an open state in which the hook portion is retracted to an outside in the third direction from the center portion of the concave portion relative to a position in the connection state when viewed from the second direction,
wherein, when the connection state is established, the attraction portion is attracted to the magnet portion, whereby the movement of the slider and the rotation of the first swinging member and the second swinging member are restricted, and the connection state is maintained, and
wherein, in the open state, a part of the first swinging member is positioned inside the concave portion when viewed from the second direction.

2. The connection apparatus according to claim 1, further comprising
a rotation force applying member configured to apply a force to the second swinging member to rotate the second swinging member around the second rotation shaft so as to establish the open state.

3. The connection apparatus according to claim 1,
wherein the first swinging member and the slider are connected on the one side relative to the center portion of the concave portion in the third direction, and
the first rotation shaft is provided on the other side relative to the center portion of the concave portion in the third direction.

4. The connection apparatus according to claim 1,
wherein the body portion is configured in a box shape,
wherein an inside of the body portion is partitioned by a partition wall portion into a first region accommodating the first swinging member and the second swinging member, and a second region accommodating the attraction portion and the magnet portion, and
wherein the slider is provided so as to penetrate the partition wall portion.

5. The connection apparatus according to claim 1,
wherein the attraction portion is attached to the slider so as to be movable in the first direction relative to the slider, and an elastic member configured to buffer a force in the first direction generated between the attraction portion and the slider is provided between the attraction portion and the slider.

6. The connection apparatus according to claim 1,
wherein a tip portion of the hook portion has an inclined edge portion that is inclined relative to the third direction such that, in the connection state, the inclined edge portion faces the other side in the first direction and is located further toward the other side in the first direction as the inclined edge portion separates from a tip of the hook portion when viewed from the second direction.

7. The connection apparatus according to claim 1, further comprising
a movement detection unit configured to detect movement of the attraction portion toward the magnet portion.

8. The connection apparatus according to claim 1, wherein the magnet portion includes an electro-permanent magnet apparatus.

9. The connection apparatus according to claim 8, further comprising
a contact detection unit configured to detect contact between the attraction portion and the magnet portion.

10. The connection apparatus according to claim 1,
wherein the first swinging member and the second swinging member are connected to the slider via a cylindrical connection member,
wherein each of the first swinging member and the second swinging member has a guide portion into which the connection member is slidably fitted,
wherein the connection member and the guide portion are provided on an opposite side to the magnet portion when viewed from the attraction portion in the first direction, and
wherein the guide portion is curved in an arc shape so as to be convex toward the opposite side to the magnet portion in the first direction when viewed from the second direction.

11. A transport body comprising the connection apparatus according to claim 1.
